(19) United States
(12) Patent Application Publication
(10) Pub. No.: US 2018/0361352 A1
(43) Pub. Date: Dec. 20, 2018

(54) CARBON DIOXIDE CAPTURE ARTICLES AND METHODS OF MAKING SAME

(71) Applicant: Corning Incorporated, Corning, NY (US)

(72) Inventors: Cheryl Barnett Gross, Columbia Cross Roads, PA (US); Nicole Melissa Keitha Blackman, Horseheads, NY (US); William Peter Addiego, Big Flats, NY (US); Jennifer Marie Rice, Painted Post, NY (US); Todd Parrish St. Clair, Painted Post, NY (US); Brian Paul Usiak, Painted Post, NY (US)

(73) Assignee: Corning Incorporated, Corning, NY (US)

(21) Appl. No.: 15/780,097

(22) PCT Filed: Nov. 29, 2016
(86) PCT No.: PCT/US2016/063899

§ 371 Date: May 30, 2018

Related U.S. Application Data
(60) Provisional application No. 62/260,771, filed on Nov. 30, 2015.

(51) Int. Cl. B01J 20/26; B01J 20/08; B01J 20/28; B01J 20/32; B01J 20/30; B01D 53/62; B01D 53/81

(52) U.S. Cl. CPC B01J 20/262; B01D 2253/3425; B01J 20/28045; B01J 20/28071; B01J 20/28073; B01J 20/28059; B01J 20/28061; B01J 20/28016; B01J 20/28004; B01J 20/3204; B01J 20/3236; B01J 20/3289; B01J 20/3293; B01J 20/3042; B01J 20/3078; B01D 53/62; B01D 53/81; B01D 2253/202; B01D 2257/504; B01D 2253/25; B01J 20/08

(57) ABSTRACT

An adsorbent article for CO₂ capture and methods of making the same. The adsorbent article for CO₂ capture includes a ceramic substrate, a plurality of inorganic support particles, and an organic CO₂ sorbent on the support particles. The ceramic substrate includes a plurality of porous partitions walls that define a plurality of open channels extending from an inlet end to an outlet end of the ceramic substrate. The organic CO₂ sorbent is supported by the inorganic support particles within the pores of porous partition walls of the ceramic substrate. The surfaces of the porous partition walls surfaces defining the open channels are essentially free of the organic CO₂ sorbent.

This application claims the benefit of priority under 35 U.S.C. § 119 of U.S. Provisional Application Ser. No. 62/260,771 filed on Nov. 30, 2015, the content of which is relied upon and incorporated herein by reference in its entirety.

### BACKGROUND

### Field

The present disclosure relates generally to adsorbent structures for carbon dioxide (CO₂) capture, and to methods of manufacturing and their use.

### Technical Background

CO₂ is a greenhouse gas that has been linked to global warming. CO₂ is a by-product of various consumer and industrial processes such as, for example, combustion of fossil fuels, purification of natural gas, oil recovery systems and the like. From an economic perspective, carbon trading and future regulations of carbon emissions from flue gases and other CO₂ point sources encourage the development of CO₂ capture technologies.

Various technologies are currently being used and/or developed to improve the capture of CO₂ from process gas streams. Such technologies include, for example, a liquid amine (MEA or KS-1) process, a chilled ammonia process, and gas membranes. While each of these technologies is effective for removing CO₂ from a process gas stream, each technology also has drawbacks. The chilled ammonia process is still in its early phases of development and the commercial feasibility of the process is not yet known. Some possible challenges with the chilled ammonia process include ammonia volatility and the potential contamination of the ammonia from gaseous contaminants such as SOx and NOx. Various gas membrane technologies are currently employed for the removal of CO₂ from process gas streams. However, processes utilizing gas membrane technologies require multiple stages and/or recycling in order to achieve the desired amount of CO₂ separation. These multiple stages and/or recycling add significant complexity to the CO₂ recovery process as well as increase the energy consumption and cost associated with the process. Gas membrane technologies also typically require high pressures and associated space constraint which makes use of the technology difficult in installations with limited space such as offshore platforms.

### SUMMARY

According to one embodiment of the present disclosure, an article is disclosed. The article comprises a ceramic substrate, a plurality of inorganic support particles, and an organic carbon dioxide sorbent. In embodiments, the ceramic substrate comprises a plurality of porous partitions walls that define a plurality of open channels. The plurality of open channels may extend from an inlet end to an outlet end of the ceramic substrate. In embodiments, the porous partition walls have a porosity from 40% to about 70%. In embodiments, the pores of the porous partitions walls have a median diameter (D50) from about 10 microns and about 30 microns. The plurality of inorganic support particles are within the pores of at least one of the porous partitions walls. In embodiments, the organic carbon dioxide sorbent is supported by at least one of the plurality of inorganic support particles within the pores of at least one of the porous partition walls.

According to another embodiment of the present disclosure, an article for CO₂ capture is disclosed. In embodiments, the article comprises a cordierite substrate, a plurality of alumina support particles, and an amine polymer carbon dioxide sorbent. In embodiments, the cordierite substrate comprises a plurality of porous partitions walls having opposite surfaces. The surfaces of the plurality of porous partitions walls may define a plurality of open channels extending from an inlet end to an outlet end of the cordierite substrate. In embodiments, the porous partition walls have a porosity from 40% to about 70%. In embodiments, the pores of the porous partitions walls have a median diameter (D50) of from about 10 microns to about 30 microns. The plurality of alumina support particles are within the pores of at least one of the porous partitions walls. The amine polymer carbon dioxide sorbent is supported by at least one of the plurality of alumina support particles within the pores of at least one of the porous partition walls. In embodiments, the surfaces of the plurality of partition walls contain 0.001 wt. % to 1 wt. % of the amine polymer CO2 sorbent.

According to yet another embodiment of the present disclosure, methods of making an article for CO₂ capture are disclosed.

### BRIEF DESCRIPTION OF THE DRAWINGS

The disclosure will be better understood, and features, aspects and advantages other than those set forth above will become apparent when consideration is given to the following detailed description thereof. Such detailed description makes reference to the following drawings.

FIG. 1 illustrates and an exemplary honeycomb ceramic substrate.

FIG. 2 is plot of the pore size distribution (microns) in ceramic substrates according to an exemplary embodiment.

FIG. 3 is a plot of the pore size distribution (microns) in an adsorbent article according to an exemplary embodiment.

FIG. 4 is a plot of slurry solids loading (wt. %) based on the wash coat loading (g/L) according to an exemplary embodiment.

FIGS. 5A-E are scanning electron microscope (SEM) images of “in-wall” coated adsorbent articles for CO₂ capture according to an exemplary embodiment.

FIGS. 6A-C are SEM images of “in-wall and on-wall” adsorbent articles for CO₂ capture according to an exemplary embodiment.

FIGS. 6D-F are SEM images of prior art “on-wall” coated adsorbent articles.

FIG. 7A-E are SEM images of prior art “on-wall” coated adsorbent articles.

FIG. 8 is a plot of CO₂ capture (calculated based on measured desorption) for adsorbent articles for CO₂ capture vs. the wt. % of PEI in the coating solution according to an exemplary embodiment.

FIG. 9 is a plot of pressure drop across adsorbent articles for CO₂ capture according to an exemplary embodiment.

FIG. 10 is a plot of CO₂ capture (calculated based on measured desorption) for adsorbent articles for CO₂ capture according to an exemplary embodiment.

### DETAILED DESCRIPTION

Unless defined otherwise, all technical and scientific terms used herein have the same meaning as commonly understood by one of ordinary skill in the art to which the disclosure belongs. Although any methods and materials similar to or equivalent to those described herein can be used in the present disclosure, exemplary methods and materials are described below.

Conventional CO₂ capture articles with supported CO₂ sorbent coatings has been based on the three-way catalyst (TWC) concept used in treating emissions from internal combustion engines. In this technology, the ceramic substrate acts as a skeleton support for washcoat (containing a CO₂ sorbent) which is deposited onto surfaces of the substrate partition walls. It has been the subject of advanced research to improve upon conventional CO₂ capture articles by increasing the mechanical durability of the CO₂ sorbent coating, increasing the activity of the coating, increasing the surface area and access to the CO₂ sorbent coating, or decreasing pressure drop across the CO₂ capture article. The inventors' present disclosure provides an adsorbent article 50 with improved performance and properties and methods of making and using the same.

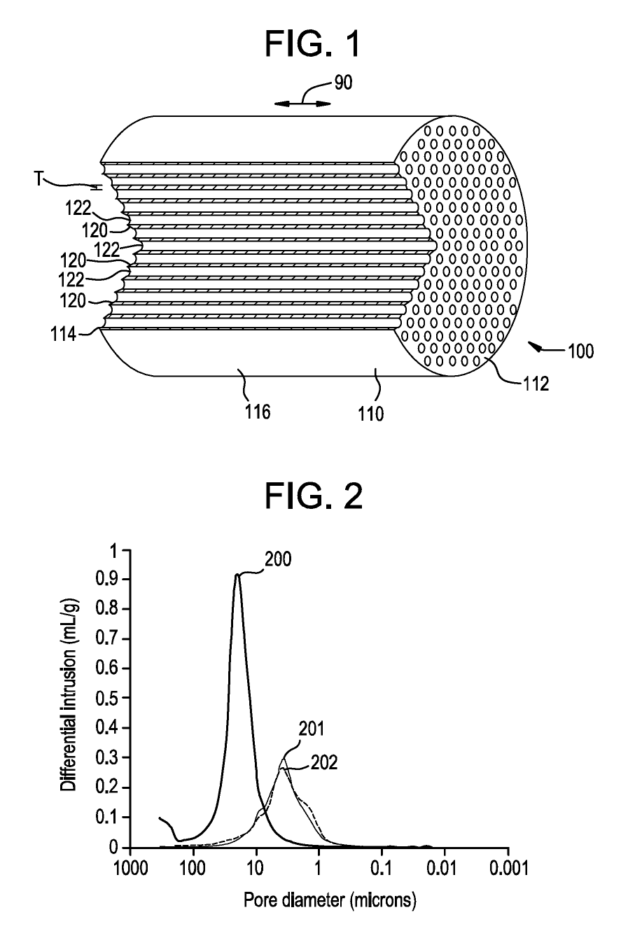

The present disclosure relates to adsorbent article 50 for CO₂ capture comprising a ceramic substrate 100, an inorganic support 102, and an organic CO₂ sorbent 104. As provided in FIG. 1, ceramic substrate 100 may include a plurality of porous partitions walls 120 that define a plurality of open channels 122. Porous partition walls 120 each have a thickness T between opposite surfaces which define the plurality of open channels 122. Open channels 122 may extend in an axial direction 90 (e.g., in a plane perpendicular to the y-axis) from an inlet end 112 to an outlet end 114 of ceramic substrate 100. In an exemplary embodiment, the plurality of partition walls 120 intersect to form a honeycomb structure as illustrated in FIG. 1. While the honeycomb ceramic substrate 100 is depicted in FIG. 1 with channels 105 having a substantially circular cross-section (e.g., in a plane perpendicular to the y-axis), in embodiments the channels can have any suitable geometry, for example, hexagonal, square, triangular, rectangular, or sinusoidal cross-sections, or any combination thereof. Additionally, although the honeycomb ceramic substrate 100 is depicted as substantially cylindrical in shape, it is to be understand that such shape is exemplary only and the porous ceramic substrate can have any variety of shapes including, but not limited to, spherical, oblong, pyramidal, cubic, or block shapes, to name a few. Open channels 122 may have a diameter of at least 0.2 mm or more up to 10 mm to limit pressure drop of the target gas across substrate 100. Ceramic substrate may have a pressure drop from about 1 millibars (mbar) to about 100 mbar for an exhaust flow rate between about 600 m³/hour and about 2750 m³/hour.

Ceramic substrate 100 may also have any variety of configurations and designs including, but not limited to, flow-through monolith, wall-flow monolith, or partial-flow monolith structures. Exemplary flow-through monoliths include any structure comprising open channels 122, porous networks, or other passages through which fluid can flow from one end of substrate 100 to the other. Exemplary wall-flow monoliths include, for example, any monolithic structure comprising open channels 122 or porous networks or other passages which may be open or plugged at opposite ends of the structure (e.g., a diesel particulate filter), thereby directing fluid flow through partition walls 120 (“wall-flow”) as it flows from one end of the structure to the other. Example methods of forming wall-flow monoliths are provided in U.S. Pat. No. 8,435,441, the content of which is incorporated by reference herein. Exemplary partial-flow monoliths can include any combination of a wall-flow monolith with a flow-through monolith, e.g., having some channels or passages open on both ends to permit the fluid to flow through the channel without blockage.

As shown in FIG. 1, ceramic substrate 100 may also include a porous skin 116 along a peripheral edge or its circumference. Skin 116 may have a thickness of about 0.1 mm to about 3.5 mm, or from about 0.5 mm to about 2.5 mm, or even from about 1 mm to about 2 mm. Skin 116 may have properties (e.g., pore diameter, pore diameter distribution, material, etc.) similar to that of partition walls 120 or may have compositions the same or similar to those provided in U.S. Pat. No. 8,999,483, the content of which is incorporated by reference herein. In alternative embodiments, skin 116 may be simply formed by converging partition walls 120. Skin 116 may be applied during or after formation of ceramic substrate 100. Skin 116 may also be produced by methods provided in U.S. Pat. No. 5,487,694 the content of which is incorporated by reference herein.

Ceramic substrates 100 in the shape of a honeycomb are often described in terms of cells (or channels) per square inch of surface area, as well as interior wall thickness (mils is equivalent to 10⁻³ inches). Thus, a honeycomb comprising 300 cells/in² and a wall thickness of 8 mils would be labeled as a 300/8 honeycomb, and so forth. Exemplary honeycombs may comprise from about 100 to about 500 cells/in² (15.5-77.5 cells/cm²), such as from about 150 to about 400 cells/in² (23.25-62 cells/cm²), or from about 200 to about 300 cells/in² (31-46.5 cells/cm²), including all ranges and subranges therebetween. According to additional embodiments, partition wall 120 thickness T can range from about 2 mils to about 20 mils (51-508 microns), such as from about 8 mils to about 16 mils (203-406 microns), e.g., about 8, 10 12, 14, or 16 mils, including all ranges and subranges therebetween. Partition wall 120 thickness T may be above 1 mil (25.4 microns) so that enough organic CO₂ sorbent 104 may be loaded therein for adsorption of CO₂. Partition wall 120 thickness T may be below about 20 mils (508 microns) so that pressure drop across the adsorption article 50 is not prohibitively high (e.g., >30 mbars at exhaust flow rate of 2750 m³/hour).

Typical honeycomb ceramic substrate 100 lengths and/or diameters can range from one to several inches, such as from about 1 inch to about 12 inches (2.54-30.48 cm), from about 2 inches to about 11 inches (5.08-27.94 cm), from about 3 inches to about 10 inches (7.62-25.4 cm), from about 4 inches to about 9 inches (10.16-22.86 cm), from about 5 inches to about 8 inches (12.7-20.32 cm), or from about 6 inches to about 7 inches (15.24-17.78 cm), including all ranges and subranges therebetween.

Ceramic substrate 100 is porous according to exemplary embodiments including a total porosity from about 40% to about 70%, or from 40% to 65%. The total porosity of ceramic substrate 100 should be above about 40% to allow inorganic support particles 102 and organic CO₂ sorbent 104 to enter porous partition walls 120. For example, conventional ceramic substrates with a permeability across its partition walls of about 4.2×10⁻¹⁴ m² or lower would likely be unsuitable for adsorbent article 50. Porosity above about 40% is also desirable to allow the CO₂ containing target gas to permeate porous partition walls 120 to contact with organic CO₂ sorbent 104. For example, ceramic substrate 100 may have a permeability across partition wall 120 from about 2×10⁻¹³ m² to about 2×10⁻¹² m² or higher. However, the total porosity of ceramic substrate 100 may be below about 70% so that ceramic substrate 100 has sufficient strength (e.g., >125 psi MOR) to withstand handling and CO₂ capture process conditions. Ceramic substrate 100 may be Celcor® substrates or DuraTrap® substrates available from Corning Incorporated, or substrates available from NGK Automotive Ceramics, Inc. (e.g., HONEYCERAM®).

In embodiments, the pore volume within porous partition walls 120 may range from about 0.1 cm³/g to about 1 cm³/g. In exemplary embodiments, individual pores within porous partition walls 120 are interconnected such that flow paths exist across porous partition walls 120 between open channels 122. Individual pores within porous partition walls 120 may have a diameter distribution between about 0.1 microns and about 500 microns, or 0.1 microns and about 250 microns, or about 1 micron to about 200 microns, or even from about 5 microns to about 90 microns. In embodiments, the plurality of pores within the plurality of partition walls 120 have a median diameter (D50) between about 5 microns and about 50 microns, or about 10 microns and about 40 microns, or even from about 12 microns to about 30 microns. Porous partition walls having a D50 below about 5 microns may limit permeability into and through the walls. Also, porous partition walls having a D50 above about 30 or 50 microns may reduce the structural integrity of the ceramic substrate such that it cannot endure frequent handling or high-flow operating conditions.

Methods of making adsorbent structures for CO₂ capture of the present disclosure include forming ceramic substrate 100. Once the cell geometry for the ceramic honeycomb substrate 100 has been determined, the honeycomb substrate 100 exhibiting the optimized cell geometry can then be formed from any conventional material suitable for forming a porous honeycomb substrate 100 body. For example, in one embodiment, substrate 100 can be formed from a plasticized ceramic forming composition. Exemplary ceramic forming compositions can include those conventionally known for forming cordierite, aluminum titanate, silicon nitride, silicon carbide, aluminum oxide, zirconium oxide, zirconia, magnesium stabilized zirconia, zirconia stabilized alumina, yttrium stabilized zirconia, calcium stabilized zirconia, magnesium stabilized alumina, calcium stabilized alumina, titania, silica, magnesia, niobia, ceria, vanadia, nitride, carbide, metal, zeolites, or any combination thereof. In embodiments, ceramic substrate 100 may be formed from at least 95 wt. % cordierite, or ≥97 wt. % cordierite, or even 99 wt. % cordierite or more.

Ceramic substrate 100 can be formed according to any conventional process suitable for forming ceramic substrate 100 bodies. For example, in one embodiment a plasticized ceramic forming batch composition can be shaped into a green body by any known conventional ceramic forming process, such as, e.g., extrusion, injection molding, slip casting, centrifugal casting, pressure casting, dry pressing, and the like. Preferably, the ceramic precursor batch composition comprises inorganic ceramic forming batch component(s) capable of forming, for example, one or more of the sintered phase ceramic compositions set forth above, a liquid vehicle, a binder, and one or more optional processing aids and additives including, for example, lubricants, and/or a pore former. In an exemplary embodiment, extrusion can be done using a hydraulic ram extrusion press, or a two stage de-airing single auger extruder, or a twin screw mixer with a die assembly attached to the discharge end. In the latter, the proper screw elements are chosen according to material and other process conditions in order to build up sufficient pressure to force the batch material through the die.

The inorganic batch components can be selected so as to yield a ceramic substrate 100 comprising cordierite, mullite, spinel, aluminum titanate, or a mixture thereof upon firing. For example, and without limitation, in one embodiment, the inorganic batch components can be selected to provide a cordierite composition consisting essentially of, as characterized in an oxide weight percent basis, from about 49 to about 53 wt. % SiO₂, from about 33 to about 38 wt. % Al₂O₃, and from about 12 to about 16 wt. % MgO. An exemplary inorganic cordierite precursor powder batch composition may comprise about 33 to about 41 wt. % aluminum oxide source, about 46 to about 53 wt. % of a silica source, and about 11 to about 17 wt. % of a magnesium oxide source. Exemplary non-limiting inorganic batch component mixtures suitable for forming cordierite include those disclosed in U.S. Pat. Nos. 3,885,977; RE 38,888; 6,368,992; 6,319,870; 6,214,437; 6,210,626; 5,183,608; 5,258,150; 6,432,856; 6,773,657; 6,864,198; and U.S. Patent Application Publication Nos.: 2004/0029707; 2004/0261384, the contents of which are incorporated by reference herein.

Alternatively, in another embodiment, the substrate 100 body can be formed from inorganic batch components selected to provide, upon firing, a mullite composition consisting essentially of, as characterized in an oxide weight percent basis, from 27 to 30 wt. % SiO₂, and from about 68 to 72 wt. % Al₂O₃. An exemplary inorganic mullite precursor powder batch composition can comprise approximately 76 wt. % mullite refractory aggregate; approximately 9.0 wt. % fine clay; and approximately 15 wt. % alpha alumina. Additional exemplary non-limiting inorganic batch component mixtures suitable for forming mullite include those disclosed in U.S. Pat. Nos. 6,254,822 and 6,238,618, the contents of which are incorporated by reference herein.

Still further, the substrate 100 body can be formed from inorganic batch components selected to provide, upon firing, an aluminum-titanate composition consisting essentially of, as characterized in an oxide weight percent basis, from about 8 to about 15 wt. % SiO₂, from about 45 to about 53 wt. % Al₂O₃, and from about 27 to about 33 percent by weight TiO₂. An exemplary inorganic aluminum titanate precursor powder batch composition can comprises approximately 10% quartz; approximately 47% alumina; approximately 30% titania; and approximately 13% additional inorganic additives.

The formed green body can then be dried to remove at least substantially all of any liquid vehicle present that may be present within the ceramic forming batch composition. As used herein, at least substantially all includes the removal of at least 95 wt. %, at least 98 wt. %, at least 99 wt. %, or even at least 99.9 wt. % of the liquid vehicle present. Exemplary and non-limiting drying conditions suitable for removing the liquid vehicle include heating the honeycomb green body at a temperature of at least 50° C., at least 60° C., at least 70° C., at least 80° C., at least 90° C., at least 100° C., at least 110° C., at least 120° C., at least 130° C., at least 140° C., or even at least 150° C. for a period of time sufficient to at least substantially remove the liquid vehicle. In one embodiment, the conditions effective to at least substantially remove the liquid vehicle comprise heating at a temperature of at least about 60° C. Further, the heating can be provided by any conventionally known method, including for example, hot air drying, or microwave drying.

After drying, the green body can then be fired under conditions effective to convert the ceramic forming batch composition into a sintered phase ceramic composition. As one of ordinary skill in the art will appreciate, the conditions effective to convert the ceramic forming batch composition into a sintered phase ceramic composition will depend, at least in part, upon the particular batch composition used to formed the honeycomb green body and will be readily obtainable to the skilled artisan without requiring any undue experimentation. However, in an exemplary embodiment, the conditions effective for converting the ceramic forming batch composition into a sintered phase ceramic composition can include firing the formed green body at a maximum firing temperature in the range of from 1350° C. to 1500° C. Maximum firing temperature in the range of from 1375° C. to 1425° C. is desirable for the formation of cordierite substrate 100.

Adsorbent article 50 for CO₂ capture also includes inorganic support 102 (not shown expressly in the figures). In embodiments, inorganic support 102 is configured as a plurality of particles within the plurality of pores of porous partition walls 120. That is, the plurality of inorganic support particles 102 are contained within the pores of at least one of the porous partitions walls 120. Inorganic support particles 102 may also be configured to support organic CO₂ sorbent 104. In one embodiment, inorganic support particles 102 fill from about 20% to about 80% of the total pore volume within partition walls 120 of substrate 100. In embodiments, open channels 122 are essentially free of inorganic support particles 102. In an exemplary embodiment, <5 wt. %, or even <1 wt. %, of the plurality of inorganic support particles 102 within substrate 100 are within open channels 122. That is, open channels 122 of substrate 100 may contain from about 0.001 wt. % to about 5 wt. %, or even from about 0.001 wt. % to about 1 wt. %, of the plurality of inorganic support particles 102 in substrate 100. Accordingly, the surfaces of partition walls 120 defining open channels 122 contain from about 0.001 wt. % to about 5 wt. %, or even from about 0.001 wt. % to about 1 wt. %, of the plurality of inorganic support particles 102 within substrate 100. Thus, ≥95 wt. %, or even ≥99 wt. %, of inorganic support particles 102 within substrate 100 are contained inside the pores of porous partition walls 120. That is, at least one of porous partitions walls 120 contains there within ≥95 wt. % of the inorganic support particles 102 in substrate 100. In embodiments, inorganic support particles 102 may be present across the entire thickness T of partition walls 120. That is, adsorbent article 50 of the present disclosure differs from conventional CO₂ capture articles where support particles on the surface of substrate partition walls may infiltrate the wall thickness by about 10-15% or less so as to secure the support coating on the partition wall.

Inorganic support particles 102 may be alumina, alumina tri-hydroxides, boehmite, gamma alumina, transition or activated alumina, silicas, and combinations thereof. In exemplary embodiments, inorganic support particles 102 are high surface area alumina. In embodiments, inorganic support particles 102 have a diameter distribution from about 0.1 microns to about 100 microns. In other embodiments, inorganic support particles 102 have a median diameter (D50) from about 1 micron to about 20 microns, or from about 2 microns to about 10 microns. Inorganic support particles 102 are configured to fit within a majority of the pores of porous partition walls 120. In an exemplary embodiment, inorganic support particles 102 have a D90 from about 1 micron to about 10 microns. Inorganic support particles 102 with D50 below about 1 microns may tend to fill the pores along the surfaces of porous partition walls 102 and inhibit other particles from reaching the center of thickness T. That is, inorganic support particles 102 may pack densely setting up regions of low permeability and inhibiting CO₂ access. Inorganic support particles 102 with D50 above about 20 microns may be too large to penetrate the porosity across the entire thickness T of porous partition walls 102. Inorganic support particles 102 may each have a surface area from about 50 m²/g to about 275 m²/g. Further, inorganic support particles 102 may each have a pore volume from about 0.1 cm³/g to about 2.5 cm³/g.

Methods of making adsorbent article 50 for CO₂ capture include inserting inorganic support particles 102 within the pores of porous partition walls 102. In one embodiment, a support precursor slurry is prepared for contacting with ceramic substrate 100. The support precursor slurry may be comprised of a plurality of inorganic support particles 102, a binder, and a liquid vehicle (e.g., solvent). The plurality of inorganic support particles 102 within the support precursor slurry may have been size reduced (e.g., milled, jet-milled ball-milled, crushed, etc.) to achieve a desired particle diameter distribution and medium diameter (D50) range in accordance with the present disclosure. In exemplary embodiments, the particles sizes of the plurality of inorganic support particles 102 are configured for insertion and retention within the pores of porous partition walls 120. The binder within the support precursor slurry may comprise an inorganic binder (e.g., colloidal boehmite, lydox silica, colloidal titania, colloidal zirconia, etc.), an organic binder (e.g., methylcellulose, polyethlyeneglycol, polyvinlyalcohol, polyvinylactetate, etc.), or combinations thereof. The binder composition may be configured to bind the inorganic support particles 102 inside porous partition walls 120. The liquid vehicle within the support precursor slurry may be water, acetic acid, acetone, toluene, ethyl alcohol, dicholoromethane, octanoic acid, and any other common organic liquids capable of acting as a delivery vehicle for the inorganic particles (and other precursor components) to the pores of porous partition walls 120. In embodiments, the support precursor slurry is mixed to achieve a homogenous mixture before contacting with ceramic substrate 100. In embodiments, the support precursor slurry has from about 1 vol. % to about 70 vol. % solids so that is able to flow into porous partition walls 120. In embodiments, the support precursor slurry may have a viscosity form about 1 centipoise (cP) to about 1000 cP and may exhibit shear-thinning properties.

Methods of contacting the support precursor slurry with ceramic substrate 100 are configured to selectively insert or imbibe inorganic support particles 102 within the pores of porous partition walls 120. For example, contacting ceramic substrate 100 and the support precursor slurry may include dip coating, spray coating, 3-D print coating, pressure impregnation, vacuum impregnation, and other similar methods. In one embodiment, a vacuum force and the support precursor slurry are positioned at opposite ends of substrate 100. The slurry is shear-thinning so that after deposition on the top end the slurry remains in place without flowing into the substrate channels. As the vacuum is applied, the force pulls the slurry along axial direction 90 of substrate 100 (shown in FIG. 1) into the pores of porous partition walls 120. That is, the method may comprise vacuum drawing the support precursor slurry into the pores of porous partition walls 120 of ceramic substrate 100. The vacuum force may be from about 1 kilopascal (kPa) to about 50 kPa and may cause sheer thinning of the support precursor slurry such that it flows into porous partition walls 120.

Methods of making adsorbent article 50 for CO₂ capture may also include calcining (i.e. heat treating) substrate 100 including the support precursor slurry. Calcining may be performed in a humidity controlled furnace at a temperature from about 100° C. to about 600° C. from about 1 hour to about 10 hours. Calcining of ceramic substrate 100 including the support precursor slurry may remove at least a portion of the support precursor slurry from ceramic substrate 100. For example, calcining may evaporate the liquid vehicle or oxidize organics (or both) within the support precursor slurry from ceramic substrate 100. Calcining may also cause the inorganic particles to bond with the pore surfaces within porous partition walls 120. In exemplary embodiments, calcining leaves inorganic support particles 102 within the pores of porous partition walls 102 with less than 1 wt. % of the solvent and binder remaining from the support precursory slurry. In another example, calcining may remove ≥99 wt. %, or even ≥99.9 wt. %, of inorganic support particles 102 within open channels 122.

Methods of making adsorbent article 50 for CO₂ capture may also include injecting pressurized gas (e.g., air, nitrogen, argon, and similar inert gases) through substrate 100 open channels 122 (including the support precursor slurry) to clear open channels 122. Injecting pressurized air through substrate 100 open channels 122 may be performed before calcining substrate 100 (including the support precursor slurry), or may also be injected after calcining.

Adsorbent article 50 for CO₂ capture of the present disclosure also includes organic CO₂ sorbent 104 (not expressly shown in the figures). Organic CO₂ sorbent 104 is configured to be supported by at least one of inorganic support particles 102. Organic CO₂ sorbent 104 may be supported within the pores of inorganic support particles 102, on the surface(s) of inorganic support particles 102, or both. Further, organic CO₂ sorbent 104 is configured to flow into the porous partition walls 120 of substrate 100 for contact with inorganic support particles 102. That is, organic CO₂ sorbent 104 is supported by at least one of the plurality of inorganic support particles 102 contained within the pores of at least one of the porous partition walls 120 of substrate 100. Thus, open channels 122 of substrate 100 may be essentially free of organic CO₂ sorbent 104.

In one embodiment, organic CO₂ sorbent 104 loading is from about 1 wt. % to about 40 wt. % of the article weight, including ceramic substrate 100 and inorganic support 102. Organic CO₂ sorbent 104 fills from about 30% to about 70% of the total pore volume within partition walls 120 of substrate 100. In an exemplary embodiment, from about 0.001 wt. % to about 5 wt. %, or even from about 0.001 wt. % to about 1 wt. %, of the CO₂ sorbent 104 within substrate 100 is within open channels 122. That is, open channels 122 of substrate 100 may contain from about 0.001 wt. % to about 5 wt. %, or even from about 0.001 wt. % to about 1 wt. %, of CO₂ sorbent 104 in substrate 100. Accordingly, the surfaces of partition walls 120 defining open channels 122 contain from about 0.001 wt. % to about 5 wt. %, or even from about 0.001 wt. % to about 1 wt. %, of CO₂ sorbent 104 within substrate 100. Thus, ≥95 wt. %, or even ≥99 wt. %, of CO₂ sorbent 104 within substrate 100 is contained within the pores of porous partition walls 120. That is, at least one of porous partitions walls 120 contains there within ≥95 wt. % of CO₂ sorbent 104 in substrate 100.

In embodiments, organic CO₂ sorbent 104 is an amine polymer such as polyethyleneimine, polyamidoamine, polyvinylamine. In other embodiments, organic CO₂ sorbent may be selected from the group consisting of monoethanolamine, diethanolamine, triethanolamine, polyethyleneimine, polyamidoamine, polyvinylamine, aminopropyltrimethoxysilane, polyethyleneimine-trimethoxysilane, 1-(2-Hydroxyethyl)piperazine, N-(3-Aminopropyl)diethanolamine, or combinations thereof.

Methods of making adsorbent article 50 for CO₂ capture further include contacting organic CO₂ sorbent 104 and calcined ceramic substrate 100 (including inorganic support particles 102). Contacting may include wash coating organic CO₂ sorbent 104 over substrate 100, soaking substrate 100 in organic CO₂ sorbent 104, or similar processes. Methods of contacting organic CO₂ sorbent 104 and ceramic substrate 100 are configured to insert and imbibe organic CO₂ sorbent 104 within the pores of the porous partition walls 120, supported by inorganic support particles 102 therein. In one embodiment, organic CO₂ sorbent 104 is part of a solution including another liquid (e.g., water, alcohols), called an organic CO₂ sorbent liquid or solution. The organic CO₂ sorbent liquid may contain from about 10 wt. % to about 60 wt. % organic CO₂ sorbent 104. In embodiments, the organic CO₂ sorbent liquid may have a viscosity form about 1 cP to about 100 cP. After contacting calcined ceramic substrate 100 (including inorganic support particles 102) and the organic CO₂ sorbent liquid, the inorganic support particles 102 and the organic CO₂ sorbent liquid together may fill between about 60% and about 100% of the porosity of porous partition walls 120.

Methods of making adsorbent article 50 for CO₂ capture may also include drying calcined ceramic substrate 100 (including inorganic support particles 102) and the organic CO₂ sorbent solution. Drying may include heating in a humidity controlled atmosphere (e.g., oven or furnace) from about 50° C. to about 100° C. Optionally, the atmosphere during drying may be inert or free or oxygen to prevent oxidation of organic CO₂ sorbent 104. Drying may also include room temperature dehydration or an air flux from about 10 hours to about 100 hours. Drying may remove at least a portion of the organic CO₂ sorbent solution from the calcined ceramic substrate 100. For example, drying may remove a portion of the liquid from the organic CO₂ sorbent solution within the calcined ceramic substrate 100. Drying may also deposit or affix a portion of organic CO₂ sorbent 104 onto or into the plurality of inorganic support particles 102 contained within the pores of at least one of porous partition walls 120. Following drying, the inorganic support particles 102 and organic CO₂ sorbent 104 together may fill between about 50% and about 95% of the porosity of porous partition walls 120.

Methods of using adsorbent article 50 for CO₂ capture may include causing relative movement between adsorbent article 50 and a target gas containing CO₂. The target gas may be from atmospheric air, flue gas from a manufacturing process (e.g., hydrocarbon combustion for electricity generation), or from other processes where CO₂ is a by-product. For example, process streams containing greater than about 200 ppm of CO₂ in the target gas. Causing relative movement may be performed by pressure or vacuum force of the target gas across axial direction 90 of article 50. Causing relative movement may also include physical movement of article 50 through the target gas. Methods of using adsorbent article 50 for CO₂ capture may also include contacting article 50 with a target gas, the target gas including CO₂, wherein article 50 captures at least a portion of the CO₂ within the target gas.

### EXAMPLES

The present disclosure will be further clarified with reference to the following examples. The following examples are illustrative and should not be construed as limiting. In the following examples, an adsorbent article according to the present disclosure was prepared and compared to two comparative examples of conventional CO₂ adsorbent articles.

### Example 1

### Preparation of an Adsorbent Article for CO₂ Capture According to the Present Disclosure

Three 2-inch (5.08 cm) diameter by 6-inch (15.24 cm) long ceramic substrates were core drilled as cylinders from a larger DuraTrap® Advanced Cordierite (AC) Sintered Substrate from Corning®. The ceramic substrates had an open channel structure from end-to-end with 200 cells/in² and partition wall thicknesses of 0.01 inch (254 microns). The ceramic substrates had a nominal intrinsic density of 2.5 g/cm³, nominal porosity of 50% (porosity of the porous partition walls), and nominal median pore size of 19 microns. The total volume (i.e., cylindrical volume) of each of the substrates is provided in Table 1 below. The ceramic substrates had a coefficient of thermal expansion (CTE) of 4×10⁻⁷° C.⁻¹ over the temperature range from 25° C. to 800° C. The pore size distribution of the three ceramic substrates is provided by line 200 in FIG. 2. A skin was applied to the periphery of each of the ceramic substrates.

An alumina support precursor slurry was prepared for application to the three ceramic substrates. SBA-200 alumina (from Sasol) was jet-milled to decrease the particle mean diameter (D50) to about 3.3 microns. To prepare the slurry solids, acetic acid was added to deionized water until the pH decreased to ˜3.5 and then size-reduced alumina support particles were added along with an AL-20 inorganic boehmite binder such that the weight ratio of alumina:boehmite ranged from 70:30 to 85:15. The above described solids and liquids were combined to form the alumina support precursor slurry with about 1-50 wt. % solids depending on the washcoat loading target. Example wt. % of alumina solids are provided in FIG. 4. The alumina support precursor slurry was ball-milled for about 15 minutes to break up any agglomerates for a resultant viscosity of about 100 cP. In embodiments, additional water may be required to compensate for the uptake of water into the high pore volume alumina. The percent solids in the slurry (and the associated viscosity) was chosen such that vacuum force across an axial direction of the substrate (i.e., from one end to the other) would shear thin the slurry and pull the slurry into the porous partition walls.

Each of the three ceramic substrates were mounted in a vacuum flow coater. The flow coater creates a ring seal around the outer diameter on each end of substrate 100. The upper end seal of the flow coater was connected to a reservoir with the alumina support precursor slurry, and the lower end seal of the flow coater was connected to a vacuum pump. Subsequently, vacuum was pulled across the ceramic substrate for about 20 seconds such that the alumina support precursor slurry shear-thinned and flowed into the porous partition walls across the entire axial length of the ceramic substrate. When the vacuum was removed, residual slurry remained in the slurry reservoir.

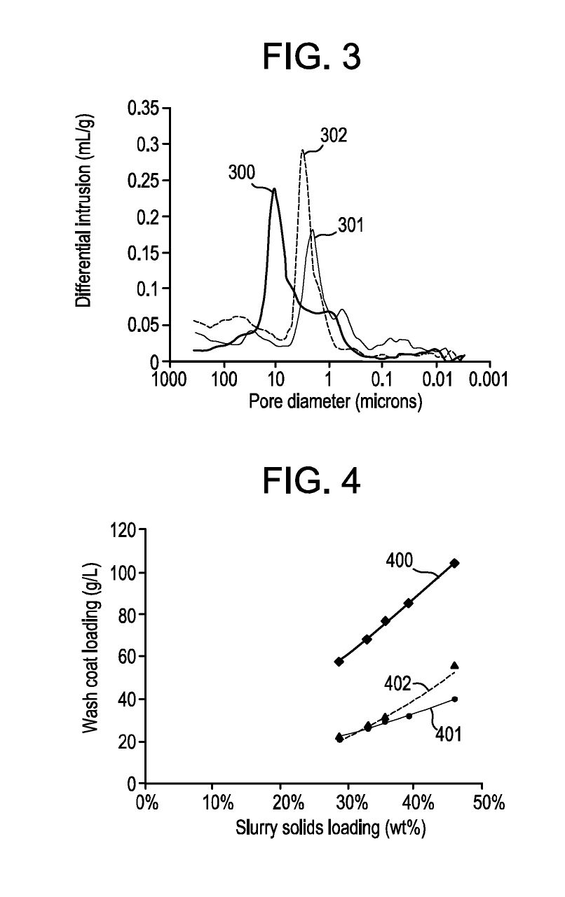

Following flow coating of the three ceramic substrates with the alumina support precursor slurry, pressurized air was used to clear excess slurry out of the channels. Following this, each substrate was calcined at about 550° C. for about 3 hours to remove at least a portion of the binder and liquid from the precursor and bond the alumina within the porous partition walls of the ceramic substrate. The alumina loading within the porous partition walls of each of the three substrates is provided in Table 1 below. Each of the three alumina containing ceramic substrates was then immersed in a solution of water and polyethyleneimine (PEI). The amount of PEI in the solution is provided in Table 1 below for each sample. Subsequently, the three ceramic substrates (with alumina supported PEI therein) were dried in an oven at about 70° C. for about 2 hours to remove at least a portion of the water from the PEI. The weight ratio of alumina to PEI in the coating with partition walls of each ceramic substrate is provided in Table 1 below. The pore size distribution of the three ceramic substrates containing alumina supported PEI is provided by line 300 in FIG. 3.

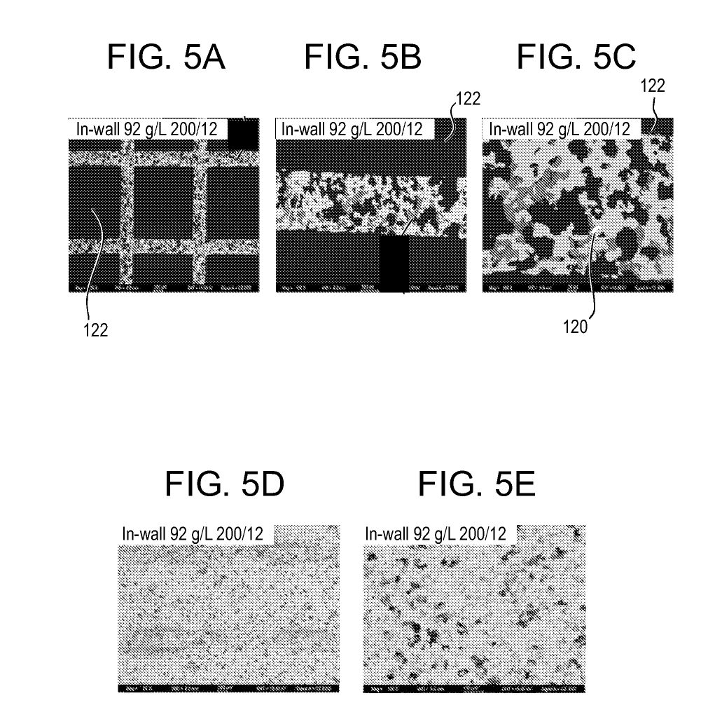

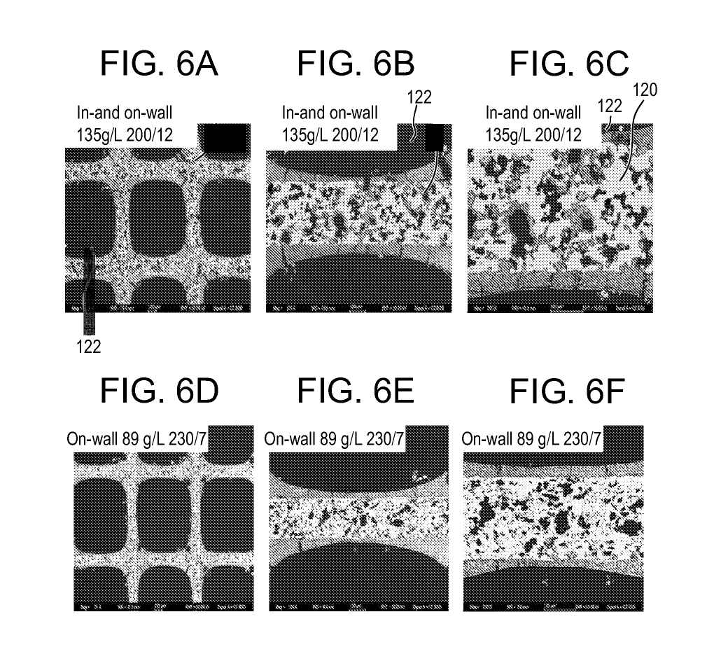

Progressively increased magnification SEM images of a cross-section of sample 2 adsorbent article for CO₂ capture (i.e., sample 2 in Table 1) are provided in FIGS. 6A-C with 135 g/L of alumina loading in the wall with slight overflow on the wall. Progressively increased magnification SEM images of a cross-section of a fourth adsorbent article for CO₂ capture are provided in FIGS. 5A-C with 92 g/L of alumina coating in the wall. Additional SEM images of the surface of a partition wall of the fourth adsorbent article for CO₂ capture are provided in FIGS. 5D-E (with SEM image 5E at higher magnification view of SEM image 5D). The SEM images show substrate channels (i.e., open space) in black, cordierite as white, and alumina supporting PEI as grey. The alumina supporting PEI (in grey) exists where voids (i.e., channels or porosity) used to exist. Comparing FIGS. 5A-C and FIGS. 6A-C, because of the higher wash coat loading (135 g/L of alumina), the walls of the ceramic substrate start to become loaded with alumina.

### Example 2

### Preparation of First Conventional CO₂ Adsorbent Article (Comparative Samples A-C)

Similar to the process in Example 1, three 2-inch (5.08 cm) diameter by 6-inch (15.24 cm) long ceramic substrates were core drilled as cylinders from a larger EX-27 Celcor® Sintered Substrate from Corning®. These were prepared as comparative samples against those prepared in Example 1. The ceramic substrates had an open channel structure from end-to-end with 400 cells/in² and partition wall thicknesses of 0.004 inch (102 microns). The ceramic substrates had a bulk density of 279 g/L, nominal porosity of about 33% (porosity of the porous partition walls), and nominal median pore size of about 3.4 microns. The total volume (i.e., cylindrical volume) of each of the substrates is provided in Table 1 below. The pore size distribution of the three ceramic substrates is provided by line 201 in FIG. 2. A skin was applied to the periphery of each of the ceramic substrates.

An alumina support precursor slurry was prepared similar to that prepared in Example 1 for application to the three ceramic substrates. Each of the three ceramic substrates were mounted in a vacuum flow coater and coated as described in Example 1. Further, each of the three ceramic substrates were air knifed and calcined as described in Example 1. The alumina loading within the porous partition walls of each of the three substrates is provided in Table 1 below. Also, each of the three alumina containing ceramic substrates were immersed in a solution of water and polyethyleneimine (PEI). The amount of PEI in the solution is provided in Table 1 below for each sample. Subsequently, the three ceramic substrates (with alumina supported PEI therein) were dried as described in Example 1. The weight ratio of alumina to PEI in the coating with partition walls of each ceramic substrate is also provided in Table 1 below. The pore size distribution of the three ceramic substrates containing alumina supported PEI is provided by line 301 in FIG. 3.

### Example 3

### Preparation of Second Conventional CO₂ Adsorbent Article (Comparative Samples D-F)

Similar to the process in Example 2, three 2-inch (5.08 cm) diameter by 6-inch (15.24 cm) long ceramic substrates were core drilled as cylinders from a larger EX-27 Celcor® Sintered Substrate from Corning, Inc. These were prepared as comparative samples against those prepared in Example 1. The ceramic substrates had an open channel structure from end-to-end with 230 cells/in² and partition wall thicknesses of 0.007 inch (178 microns). The ceramic substrates had a nominal porosity of about 33% (porosity of the porous partition walls), and nominal median pore size of about 3.4 microns. The total volume (i.e., cylindrical volume) of each of the substrates is provided in Table 1 below. The pore size distribution of the three ceramic substrates is provided by line 202 in FIG. 2. A skin was applied to the periphery of each of the ceramic substrates.

An alumina support precursor slurry was prepared similar to that prepared in Example 1 for application to the three ceramic substrates. Each of the three ceramic substrates were mounted in a vacuum flow coater can coated as described in Example 1. Further, each of the three ceramic substrates were air knifed and calcined as described in Example 1. The alumina loading within the porous partition walls of each of the three substrates is provided in Table 1 below. Also, each of the three alumina containing ceramic substrates were immersed in a solution of water and polyethyleneimine (PEI). The amount of PEI in the solution is provided in Table 1 below for each sample. Subsequently, the three ceramic substrates (with alumina supported PEI therein) were dried as described in Example 1. The PEI wt. % in the washcoat for each sample is provided in Table 1 below and was calculated weight of PEI divided by the sum of the PEI and alumina in the washcoat. The weight ratio of alumina to PEI in the coating with partition walls of each ceramic substrate is also provided in Table 1 below. The pore size distribution of the three ceramic substrates containing alumina supported PEI is provided by line 302 in FIG. 3.

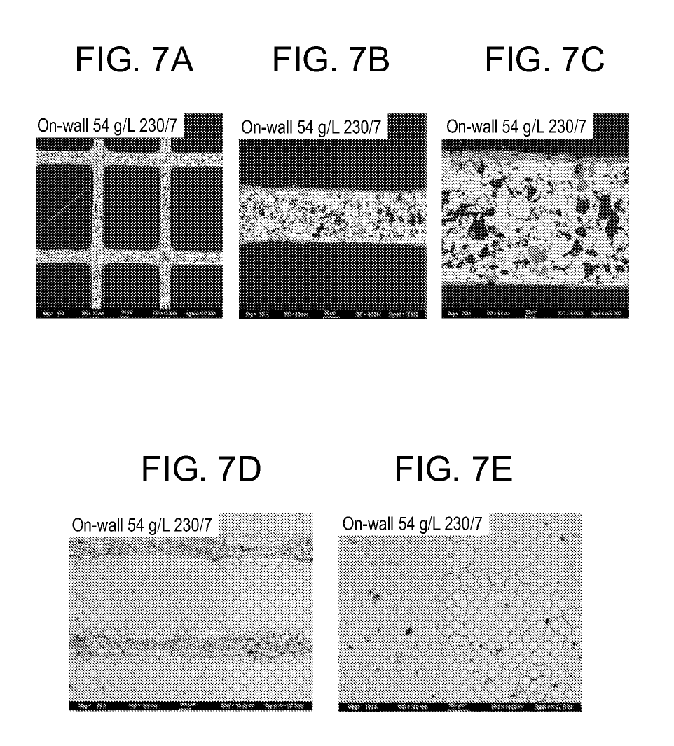

Progressively increased magnification SEM images of a cross-section of a fourth adsorbent article for CO₂ capture are provided in FIGS. 6D-F with 89 g/L of alumina loading on the wall with slight in-wall penetration. Progressively increased magnification SEM images of a cross-section of a fifth adsorbent article for CO₂ capture are provided in FIGS. 7A-C with 54 g/L of alumina coating on the wall. Additional SEM images of the surface of a partition wall of this fifth adsorbent article for CO₂ capture are provided in FIGS. 7D-E (with SEM image 7E as an enhanced, higher magnification view of SEM image 7D). The SEM images show substrate channels (i.e., open space) in black, cordierite as white, and alumina supporting PEI as grey. The alumina supporting PEI (in grey) exists where voids (i.e., channels or porosity) used to exist.

TABLE 1
Properties of Each of the Three Samples Prepared in Examples 1-3

| | | | Alumina | PEI | PEI | |
|---|---|---|---|---|---|---|
| | | Sample | loading on | wt. % | wt. % | grams |
| Exam- | | Volume | substrate | in | in dried | PEI:grams |
| ple | Sample | (L) | (g/L) | solution | washcoat | Alumina |
| 1 | 1 | 0.3175 | 115 | 30% | 54.9% | 1.22 |
| | 2 | 0.3135 | 135 | 38% | 53.1% | 1.13 |
| | 3 | 0.3199 | 112 | 45% | 60.4% | 1.52 |
| 2 | A | 0.3179 | 88 | 30% | 57.8% | 1.37 |
| | B | 0.3001 | 89 | 38% | 58.6% | 1.41 |
| | C | 0.3161 | 86 | 45% | 65.5% | 1.90 |
| 3 | D | 0.3371 | 103 | 30% | 54.5% | 1.20 |
| | E | 0.3214 | 100 | 38% | 58.9% | 1.43 |
| | F | 0.3080 | 103 | 45% | 62.3% | 1.65 |

### Example 4

### Alumina Support Precursor Slurry Solids vs. Loading on Ceramic Substrate

To illustrate the relationship between the percent solids in the alumina support precursor slurry and loading on the ceramic substrate, a separate experiment was conducted. Five, 1 in³ (16.38 cm³) cubes were drilled out from each of the three larger substrates from Examples 1-3 to form fifteen individual flow-through substrates. Each of the fifteen substrates were submerged for 30 seconds in alumina support precursor slurries having different solids therein (from 30 wt. % to 45 wt. %). The alumina loading on each of 15 ceramic substrates was measured by weight difference after calcination. The 5 resultant data points and 3 linear fit lines are provided in the plot in FIG. 4. The 5 data points (diamonds) from the DuraTrap® AC Sintered Substrate with 200 cells/in² and partition wall thicknesses of 0.01 inch (254 microns) are fit by line 400. The 5 data points (circles) from EX-27 Celcor® Sintered Substrate with 400 cells/in² and partition wall thicknesses of 0.004 inch (102 microns) are fit by line 401. The 5 data points (triangles) from EX-27 Celcor® Sintered Substrate with 230 cells/in² and partition wall thicknesses of 0.007 inch (178 microns) are fit by line 402. The results in FIG. 4 provide that the porosity of the porous walls provide greater capacity for capturing the alumina particles. This explains the separation between fit line 400 above fit lines 401 and 402.

### Example 4

### CO₂ Adsorption and Desorption Testing for Example 1-3 Adsorption Articles

Each of the adsorption articles from Examples 1-3 were separately evaluated for CO₂ adsorption and desorption capability. During the processes each adsorption article was degassed in the reactor for an hour at 85° C. by flowing pure nitrogen there through at 500 cubic centimeters per minute. Then a target gas with 10% CO₂ (balance gas N₂) was introduced at 500 cm³/min through the reactor and across the articles separately. The adsorption of CO₂ by the article was determined by measuring the concentration difference in the target gas stream over time. After saturation (resulting in approximately 100% CO₂ break-through, the articles were flushed with pure N₂ for 30 minutes. The articles were then heated in N₂ to desorb the CO₂ in the articles separately. Desorption was monitored by Fourier Transform Infrared (FTIR) spectroscopy.

Using the desorption data from each of 3 adsorption articles from Examples 1-3, the volume of the article was scaled up to a 6 inch by 6 inch by 6 inch article (assuming the larger volume part would adsorb and desorb equivalently to the 2 inch diameter by 6 inch long article). These 9 resultant data points (3 from each of Examples 1-3) and 3 linear fit lines are provided in the plot in FIG. 10. The 3 data points (diamonds) from the Example 1 articles are fit by line 700. The 3 data points (circles) from the Example 2 articles are fit by line 701. The 3 data points (triangles) from the Example 3 articles are fit by line 702. It was unexpected that the Example 1 adsorption articles would provide higher adsorption (and desorption) of CO₂ as compared to the Examples 2 & 3 articles. One of ordinary skill in the art would have expected that locating the alumina particles within the partition wall (with alumina support PEI therein) would limit adsorption as compared to alumina support PEI on the wall.

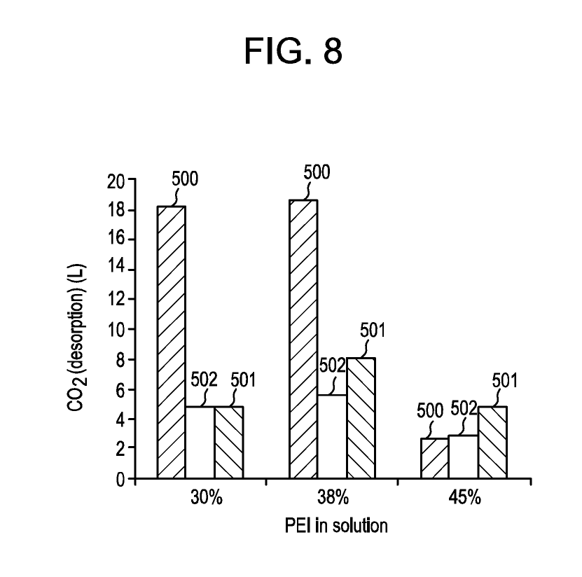

FIG. 8 provides a bar graph of CO₂ capture (based on desorption) from each of the 9 adsorption articles (scaled up to a 6 inch by 6 inch by 6 inch article) from Examples 1-3 vs. the wt. % of PEI (at 30%, 38%, and 45%) in the coating solution. This data demonstrates that the 200/12 porous wall samples had significantly higher CO2 uptake and in fact are a more efficient use of the washcoat than the on-wall samples. The three Example 1 articles are represented by bars labeled 500, the three Example 2 articles are represented by bars labeled 501, and the three Example 3 articles are represented by bars labeled 502.

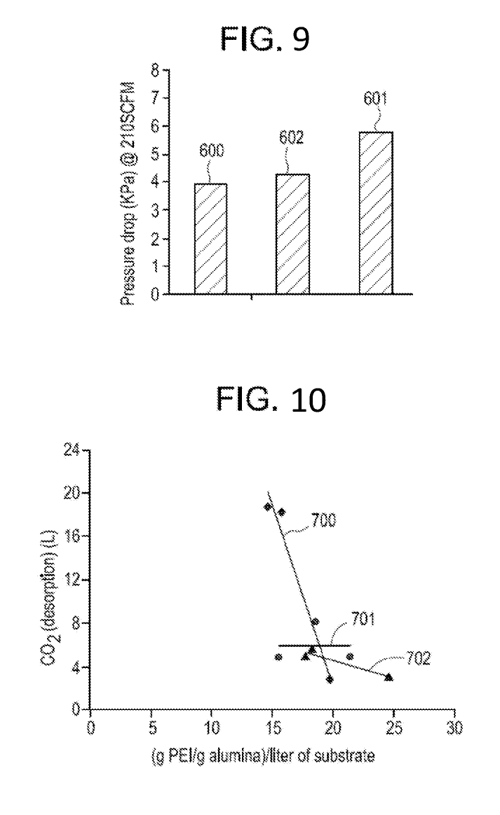

FIG. 9 provides a bar graph of the modeled pressure drop in kPA calculated at 210 standard cubic feet per minute (SCFM) across each of three articles in Examples 1-3. The modeled pressure drop for the three Example 1 articles was about 3.9 kPA as represented by bar 600 in FIG. 9. The modeled pressure drop for the three Example 2 articles was about 5.8 kPA as represented by bar 601 in FIG. 9. The modeled pressure drop for the three Example 3 articles was about 4.2 kPA as represented by bar 602 in FIG. 9. Accordingly, despite the alumina supported PEI in the wall in Example 1, the pressure drop penalty was lower than in the comparative (on wall coating) Examples 2 & 3.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

As used herein, the singular forms “a,” “an,” and “the” include plural referents unless the context clearly dictates otherwise. Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

It is also noted that recitations herein refer to a component of the present invention being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

It will be apparent to those skilled in the art that various modifications and variations can be made to the present disclosure. Since modifications combinations, sub-combinations and variations of the disclosed embodiments incorporating the substance of the present disclosure may occur to persons skilled in the art, the present disclosure should be construed to include everything within the scope of the appended claims and their equivalents.

1. An article comprising:
a ceramic substrate comprising a plurality of porous partitions walls that define a plurality of open channels,
the plurality of open channels extend from an inlet end to an outlet end of the ceramic substrate,
the porous partition walls have a porosity from 40% to about 70%,
the pores of the porous partitions walls have a median diameter (D50) from about 10 microns and about 30 microns,
a plurality of inorganic support particles within the pores of at least one of the porous partitions walls, and
an organic carbon dioxide sorbent supported by at least one of the plurality of inorganic support particles within the pores of at least one of the porous partition walls.

2. The article of claim 1 where in the open channels of the ceramic substrate contain from 0.001 wt. % to 1 wt. % of the organic carbon dioxide sorbent in the ceramic substrate.

3. The article of claim 1 wherein the open channels of the ceramic substrate contain from 0.001 wt. % to 1 wt. % of the plurality of inorganic support particles the ceramic substrate.

4. The article of claim 1 wherein the plurality of inorganic support particles and the supported organic carbon dioxide sorbent fill between from about 50 vol. % and about 99 vol. % of the porosity of the porous partition walls.

5. The article of claim 1 wherein the ceramic substrate has a pressure drop from 0.01% to 5% less than the ceramic substrate containing the plurality of inorganic support particles and the organic carbon dioxide sorbent.

6. The article of claim 1 wherein the ceramic substrate is selected from the group consisting of cordierite, silicon nitride, zircon mullite, spodumene, alumina-silica magnesia, zircon silicate, sillimanite, magnesium silicates, zircon, petalite, alumino silicates, or combinations thereof.

7. The article of claim 1 wherein the ceramic substrate is comprised of at least 95 wt. % cordierite.

8. The article of claim 1 wherein the plurality of partition walls have at least one of: a pore volume of about 0.1 cm³/g to about 1 cm³/g; a thickness from about 51 microns to about 508 microns; or a permeability from about 2×10⁻¹³ m² to about 2×10⁻¹² m².

9. The article of claim 1 wherein the pores of the plurality of porous partitions walls have a diameter of from about 0.1 microns to about 500 microns.

10. The article of claim 1 wherein each of the plurality of inorganic support particles have a surface area from about 50 m²/g to about 275 m²/g.

11. The article of claim 1 wherein each of the plurality of inorganic support particles have a pore volume from about 0.1 cm³/g to about 2.5 cm³/g.

12. The article of claim 1 wherein the plurality of inorganic support particles are alumina.

13. The article of claim 1 wherein the plurality of inorganic support particles have at least one of: a diameter from about 0.1 microns to about 100 microns; or a median diameter (D50) from about 1 microns to about 20 microns.

14. The article of claim 1 wherein the at least one of the porous partitions walls contains there within greater than or equal to 99 wt. % of the plurality of inorganic support particles in the ceramic substrate.

15. The article of claim 1 wherein the organic CO₂ sorbent is selected from the group consisting of monoethanolamine, diethanolamine, triethanolamine, polyethyleneimine, polyamidoamine, polyvinylamine, aminopropyltrimethoxysilane, polyethyleneimine-trimethoxysilane, 1-(2-Hydroxyethyl)piperazine, N-(3-Aminopropyl)diethanolamine, and combinations thereof.

16. The article of claim 1 wherein the at least one of the porous partitions walls contains there within greater than or equal to 99 wt. % of the organic CO₂ sorbent in the ceramic substrate.

17. An adsorbent article for CO₂ capture comprising:
a cordierite substrate comprising a plurality of porous partitions walls having opposite surfaces,
the surfaces of the plurality of porous partitions walls define a plurality of open channels extending from an inlet end to an outlet end of the cordierite substrate,
the porous partition walls have a porosity from 40% to about 70%,
the pores of the porous partitions walls have a median diameter (D50) of from about 10 microns to about 30 microns,
a plurality of alumina support particles within the pores of at least one of the porous partitions walls, and
an amine polymer CO₂ sorbent supported by at least one of the plurality of alumina support particles within the pores of at least one of the porous partition walls,
the surfaces of the plurality of partition walls contain 0.001 wt. % to 1 wt. % of the amine polymer CO₂ sorbent.

18. The article of claim 17 wherein the surfaces of the partition walls defining the plurality of open channels contain 0.001 wt. % to 1 wt. % of the plurality of alumina support particles in the cordierite substrate.

19. A method for making the article of claim 1 comprising:
contacting the ceramic substrate and a support precursor slurry to imbibe the plurality of inorganic support particles therein within the pores of at least one of the porous partitions walls of the ceramic substrate,
wherein the support precursor slurry comprises the plurality of inorganic support particles, a binder, and a solvent,
calcining the contacted ceramic substrate to remove at least a portion of the support precursor slurry from the ceramic substrate, and
contacting the calcined ceramic substrate with an organic CO₂ sorbent solution,
wherein the organic CO₂ sorbent solution comprises the organic CO₂ sorbent and a solvent.

20. The method of claim 19 further comprising drying the solution on the contacted and calcined ceramic substrate to remove at least a portion of the solvent and deposit a portion of the organic CO₂ sorbent onto the plurality of inorganic support particles contained within the pores of at least one of the porous partition walls.
